(19) United States
(12) Patent Application Publication
(10) Pub. No.: US 2007/0206512 A1
(43) Pub. Date: Sep. 6, 2007

(54) NETWORK DATA MODEL AND TOPOLOGY DISCOVERY METHOD

(75) Inventors: Mark Hinds, Ottawa (CA); Radmila Kovacevic, Kanata (CA); Dave Miedema, Ottawa (CA); Darren Hennigar, Nepean (CA); Cindy Pu, Kanata (CA)

Correspondence Address: BORDEN LADNER GERVAIS LLP, WORLD EXCHANGE PLAZA, 100 QUEEN STREET SUITE 1100, OTTAWA, ON, K1P 1J9, US

(73) Assignee: NORTEL NETWORKS LIMITED, St. Laurent (CA)

(21) Appl. No.: 11/548,090

(22) Filed: Oct. 10, 2006

Related U.S. Application Data
(63) Continuation-in-part of application No. 11/427,613, filed on Jun. 29, 2006.
(60) Provisional application No. 60/778,381, filed on Mar. 3, 2006.

(51) Int. Cl. H04L 12/28; H04L 12/56

(52) U.S. Cl. 370/254; 370/400

(57) ABSTRACT

A network topology data record provides a information upon the basis of which a network topology can automatically be generated. A topology resolution record can include network element or shelf/path data, as well as relationship data including a network element grouping identifier, such as a site identifier. The record can also include affiliation data, such as line adjacency, associated shelf adjacency, photonic adjacency, and service layer device adjacency. A network topology is generated, without user input, based on the automatically discovered network topology information. Topology resolution data is stored at the network level, without need for interaction with a management layer. The data record also enables a graphical user interface for network management in which a user can switch and zoom between a plurality of views in a context-sensitive manner, each view showing relationship or interconnection information for the network elements.

### CROSS REFERENCE TO RELATED APPLICATIONS

This application is a continuation-in-part of U.S. patent application Ser. No. 11/427,613 filed Jun. 29, 2006 which claims the benefit of priority of U.S. Provisional Patent Application Ser. No. 60/778,381 filed Mar. 3, 2006, both of which are incorporated herein by reference.

### FIELD OF THE INVENTION

The present invention relates generally to network management. More particularly, the present invention relates to a data model and method for management of telecommunications networks and topology discovery.

### BACKGROUND OF THE INVENTION

Network management is an important feature of complex telecommunications networks. In a complex network, there are many different aspects (e.g., layers, connections, channels, nodes, cards and ports) which can be managed. Many of these aspects have thus far been managed by disassociated applications. Representing all of these aspects to someone managing the network has been extremely challenging with existing graphical user interfaces.

The concept of branching in optical networks introduces a new level of interconnectedness at the network level. Branching provides the ability to optically route between network elements co-located on a site, and effectively between different management and control regions within a large network with multiple independently managed and controlled groupings of network elements. Since functional interaction often requires interaction with more than one shelf, a display of more than one shelf is therefore desired.

Known underlying data models are limited in their contents and consequently cannot support or enable many desired applications, such as enhanced graphical user interfaces for network management. There is also a need for a method to automatically acquire network topology information, rather than have a user manually provide such information and potentially introduce errors by way of this manual provision.

### SUMMARY OF THE INVENTION

In an aspect, the present invention provides a computer readable medium storing a network element data set, or network topology data structure, for network element management including: distribution indexing data including routing information describing a network topology from the perspective of a selected network element; network element data including technical characteristics of the selected network element; and relationship data representing logical and physical relationships between the selected network element and other network elements. The relationship data can include a network element grouping identifier representing a grouping to which the network element belongs. The network element grouping identifier can include: a site identifier representing a physical grouping to which the network element belongs; or domain optical controller status data to indicate location. The network element data can represent a particular shelf or path of the network element. The network element data is preferably automatically discovered network element data, and can include: shelf/path data or service layer device transmitter and receiver data. The relationship data is preferably automatically discovered relationship data, and can include: line adjacency data; network topology construction data; associated shelf adjacency data; photonic adjacency data; service layer adjacency data; service layer device transmitter and receiver data; channel inventory data; channel availability data; or equipment list data. The network element data and the relationship data can be stored at a network level independent of a management layer.

In another aspect, the present invention provides a method of generating a network topology including: automatically discovering network topology information based on element and relationship data stored at each network element, preferably without user input; and generating the network topology based on the automatically discovered network topology information. The step of generating the network topology can include generating an ordered list of sections per network path by tracing network element interconnectiveness within an optical system ID (OSID). The step of automatically discovering the network topology information can include automatically discovering optical system topology information, in which case the step of generating the network topology can include generating an optical system topology based on the automatically discovered optical system topology information. The method can further include: storing the automatically discovered network topology information at a network level independent of a management layer; identifying domain optical controller (DOC) sites, either within an OSID or in the entire network, based on the automatically discovered network topology information; identifying all network elements associated with a DOC based on the automatically discovered network topology information; tracing an optical channel path end to end based on the automatically discovered network topology information; generating a list of shelves for a selected site; or validating a connection by comparing the automatically discovered network topology information with expected provisioning information.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a network topology data record according to an embodiment of the present invention;

FIG. 2 illustrates a network topology showing interrelationships between network elements;

FIG. 3 illustrates a network topology data record according to another embodiment of the present invention;

FIG. 4 illustrates a method of automatic topology generation according to an embodiment of the present invention; and

FIG. 5 illustrates an 8-span closed ring network topology with four domains;

FIGS. 6A-6C illustrate OST retrieve records for elements in FIG. 5;

FIG. 7 illustrates a network topology showing service layer relationships;

FIG. 8 illustrates a network topology data record according to a further embodiment of the present invention; and

FIG. 9 illustrates a network topology data record according to a yet further embodiment of the present invention.

### DETAILED DESCRIPTION

Generally, the present invention provides a network topology data record that provides information upon the basis of which a network topology can automatically be generated. A topology resolution record can include network element or shelf/path data, as well as relationship data including a network element grouping identifier, such as a site identifier. The record can also include affiliation data, such as line adjacency, associated shelf adjacency, photonic adjacency, and service layer device adjacency. A network topology is generated, without user input, based on the automatically discovered network topology information. Topology resolution data is stored at the network level, without need for interaction with a management layer. The data record also enables a graphical user interface for network management in which a user can switch and zoom between a plurality of views in a context-sensitive manner, each view showing relationship or interconnection information for the network elements.

A data model according to an embodiment of the present invention can be used to power a GUI such as described in parent U.S. patent application Ser. No. 11/427,613 filed Jun. 29, 2006 and entitled “Graphical User Interface for Network Management”. Such a GUI provides a plurality of views of a network and its elements in the same viewing engine. A user can switch between the plurality of views in a context-sensitive manner, each view showing relationship or interconnection information. The GUI allows a user to view inter-related objects at the same level, and to view at a lower level sub-objects that make up each of those objects. Different functional views can be provided at the same hierarchical or logical level based on the stored relationship information. A relationship can be a physical connection or a logical connection or grouping. A user can navigate between a network level view, a site level view, a shelf level view, and a schematic/card level view, via element selection or by zooming, permitting a user managing a network to conveniently navigate the management aspects of the network from a single application and from a single entry point. A network element data set, to be described in detail herein, provides context-sensitive data and images to each level and view for that network element and enables automatic generation of a network topology.

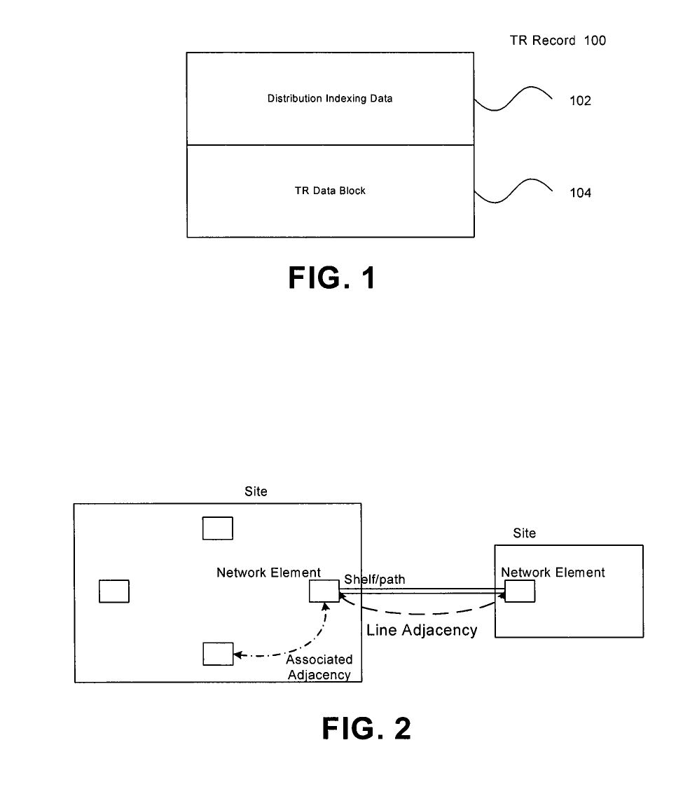

FIG. 1 illustrates a network topology data record 100 according to an embodiment of the present invention. The network topology data record can alternatively be referred to as a network element data set or a network topology data model. The data record can be stored on a computer readable medium for network element management. Distribution indexing data 102 enables or facilitates distribution of the record among network elements in the network topology. Distribution indexing data is used to manage each network element's topology resolution record and is important in the distribution of data since it identifies the owner of each record. The distribution indexing data 102 can include information such as: a sequence number, source and destination address, age, router ID, type, etc. In an embodiment, the distribution indexing data 102 comprises open shortest path first (OSPF) header information. OSPF is defined by an IETF standard and is part of a generic family of discovery protocols that can be used with this application and is one way to support the broadcast and collection of records among interconnected network elements. However, any standard-based or proprietary distribution indexing data format and related content can be used.

Topology resolution data 104 includes information gathered by a topology resolution process or method. In an embodiment, the topology resolution data 104 comprises network element data including technical characteristics of a selected network element. The network element data can be referred to as shelf/path data. The topology resolution data 104 can also comprise relationship data representing logical and physical relationships between the selected network element and other network elements. The relationship data can be described as data specific to a topology resolution process, and can be referred to as adjacency data. The relationship data includes a network element grouping identifier representing a grouping to which the network element belongs. The network element grouping identifier can represent either a logical or a physical grouping to which the network element belongs. The network element grouping identifier can be: a site identifier representing a physical grouping to which the network element belongs, such as describing physical co-location of shelves at a physical location; an optical system identifier representing a logical relationship used for control purposes; domain optical controller (DOC) status data to indicate location; or a master network element type identifier, identifying a special NE type set as a master and used for control purposes. The site identifier enables the ability to draw a network topology, and is important to the visualization aspects.

FIG. 2 illustrates a network topology showing interrelationships between network elements. In FIG. 2, a network element can have more than one shelf, or more than one optical path, or light path, referred to simply as a path. Each shelf/path has its own topology resolution (TR) record. The concept of line adjacency is shown in FIG. 2 as defining a relationship between two shelves or paths being adjacent to one another with respect to a particular connection path. The connection path can, and typically does, bridge two different sites since shelves or paths having line adjacency are typically not at the same physical site. Line adjacency data is preferably collected for each direction on a line or fiber pair. In an embodiment, this data is populated by another application or function running independently of the distribution mechanism. The concept of associated adjacency is also shown in FIG. 2 as defining a relationship between network elements co-located on the same site. Associated adjacency data can be referred to as an associated shelf record, and can include neighbor information, such as number of neighbors. Each neighbor has an adjacency connection status, which is collected to perform validation on the shelves. By definition, there can only be one associated shelf on each optical system ID (OSID).

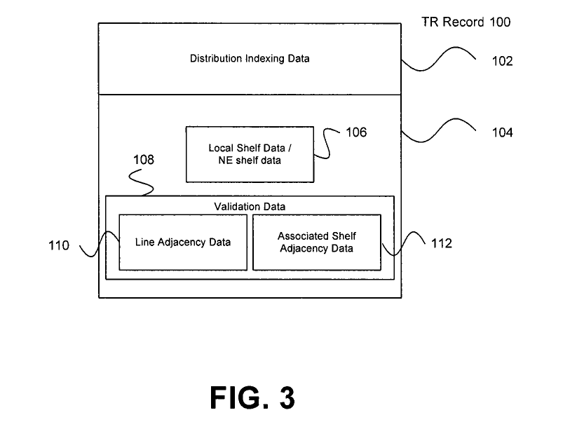

FIG. 3 illustrates a network topology data record according to another embodiment of the present invention, incorporating concepts introduced in FIG. 2. The topology resolution data 104 in the network element data record 100 is shown to include local shelf/path data 106, also referred to as NE shelf data. The TR data includes adjacency data 108, also referred to as validation data or data used to construct the network. The adjacency data 108 comprises line adjacency data 110 and associated shelf/path adjacency data 112. The line adjacency data and associated shelf adjacency data are both preferably discovered adjacency data, rather than manually input adjacency data.

The local shelf/path data 106 includes data that is typically a subset of the entire available set of data that characterizes a network element. It can generically be described as path data, since a particular shelf can have one or more terminations. The local shelf/path data describes all of the information about one location terminating one direction of a fiber pair. This can alternatively be referred to as the optical transport section termination point. The local shelf/path data 106 can include many different types of data, such as: a site ID, which is common for all shelves/paths at the same site; a shelf/path ID, which is specific to each shelf/path in a site; an OSID which identifies the optical system to which the shelf/path belongs, and may be different for different shelves/paths at different sites or at the same site; shelf function information, for example describing whether the shelf functions an amplifier or as a channel access; IP address, which can be converted to a node name; DOC site information; and/or DOC status. A DOC site manages and controls an OSID and defines its end points. There are two DOCs within an OSID, one per direction. Most of the above described data, with the exception of the IP address, can be displayed in one of the views of a zoomable user interface as described in the parent application. However, the IP address is inherently displayed by way of the node name and shelf number.

Using the adjacency data 108, the system can draw the network and can also validate inter-connections and failed provisioning. In other words, the adjacency data can enable different functions. As an example, when the network is visually displayed, actual network topology information can be compared to expected network topology information. A connection is deemed to be invalid if it does not agree with what is expected or with provisioning data. This process is referred to as validation. For example, finding three nodes provisioned as DOC sites in the same OSID is not valid since there can only be two DOC sites per OSID. Validation can be performed by methods and/or software specifically written to make such determinations based on expected provisioning information. Validation is performed on as many inter-connected shelves as exist and, for example, can be based on associated shelf adjacency data within an OSID. An alarm is typically generated if an invalid connection is detected.

The TR database can provide useful data to many applications, and many different types of information can be derived from the TR database. For instance, interconnections at a site can be discovered by parsing information in the TR database rather than by examining an individual TR record. The TR database can enable network management functionality, such as: identifying DOC sites in an OSID (two per OSID); identifying the per DOC direction network path, which is an ordered lists of NEs per DOC; and identifying all DOCs in the entire network. Also available is data relating to shelves at a site and NE placement on a site. With respect to the per DOC direction network path, it is possible to identify everything that is associated with a DOC, which would result in a list providing, in order, the NE in question, followed by every NE in its path to the point were it terminates in its partner DOC. Individual channels or wavelengths flowing in this network can use that information or subsets of that information to establish the path of end use that they travel trough. For instance, for a look-up process if the NE and direction are known by the path ID, it is possible to identify which DOC a selected shelf/path is a part of. When seeking a partner for that connection, it is possible to identify what that partner has to be a part of. There are lower level algorithms that make use of this data to trace and validate a path that a new channel would follow, or that an existing channel follows. Other applications using data in the TR database include: validation or consistency verification module, and associated shelf validation application, and the OST retrieve application which takes this information and generates it in a record as will be described later.

The TR database provides the ability to provide large amounts of information that may be available now or in the future at a particular NE. There is a significant advantage since all of these data collections can be obtained on the basis of a single TR database, without having to communicate with an upper management layer or even have an upper management layer.

In embodiments of the present invention, each NE preferably has network-aware functionality, meaning that every shelf is aware of the entire network, in contrast to simply being aware of neighboring elements. There is enough data stored in each network element data set, regardless of the network element type or configuration, to describe all of the network elements it connects to. This provides an organizational benefit since it is not necessary to negotiate with one or more different types of management systems in order to deploy a new application on a network, such as by negotiating an exchange protocol.

Therefore, as long the network has been set up correctly, it can discover its own topology information. This is different from known implementations requiring a separate computer at a management layer to receive messages from both parties in a message delivery (resulting in data duplication), to gather together all of the information and push it back down to the network. In such approaches, typically each NE does not have the capability to download this information because it would be too bandwidth intensive and would slow down network performance to much.

Topology resolution and topology discovery functions according to embodiments of the present invention are performed within the network itself, independently of any network management function or layer. This functionality can be described as being provided “in-skin”. The term “network” as used herein represents a plurality of inter-connected network elements and does not include anything at a higher layer than the network, such as at a management layer. The network can be described as a transport network or a photonic network. Performing the functions within the network can alternatively be described as performing them at a network photonic layer. Of course, although embodiments of the present invention operate independently of any management function, if other management functions are required due to size of network or other factors, such management functions can be added to a network that implements this method. Independence from any network function or scheme also provides for enhanced interoperability.

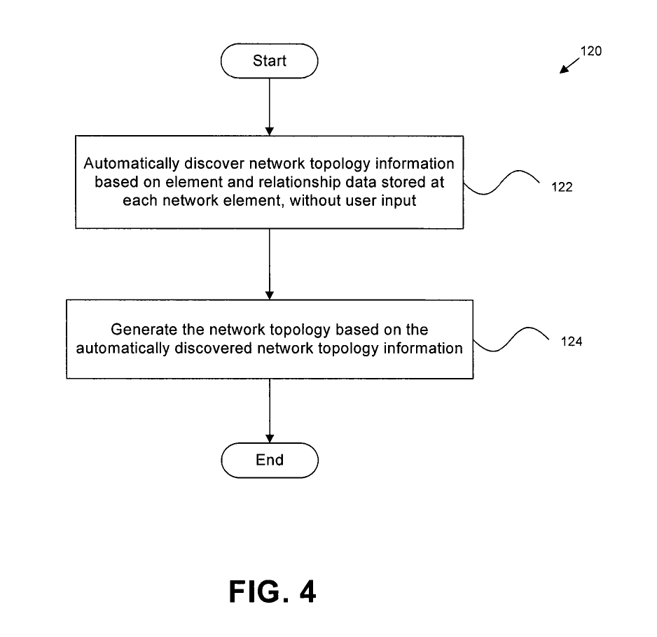

FIG. 4 illustrates a method 120 of automatic topology generation according to an embodiment of the present invention. Most network management applications require manual user definition of network element topology. Embodiments of the present invention obviate the need for manual user input by providing for automatic discovery and generation of a network topology. While collection of OSPF data is known, there are no similar approaches to collecting topology data. The discovery mechanism of embodiments of the present invention also permit depiction of linear and ring topologies, and multiple domains in a network. Prior approaches do not use discovered information from the network itself to draw a network topology. Since information about the entire network is available at each NE, embodiments of the present invention provide a distributed discovery mechanism that is self-launched based on the location where you log in to the network.

In step 122 in FIG. 4, network topology information is automatically discovered based on element and relationship data stored at each network element. The automatic discovery is preferably performed without user input, meaning that the user does not input any of the information. While the network topology discovery process is preferably automatically initiated by the network itself, provision is made for a user to initiate the process in particular circumstances. In step 124, the network topology is generated based on the automatically discovered network topology information. As mentioned earlier, known approaches do not use automatically discovered data to generate a network topology, but rather rely on user-inputted or manually inputted data. The method of FIG. 4 is preferably available at every point in the network, and is able to handle branching in the network, as well as spurs and multi-connected nodes.

One particular embodiment of automatic network topology generation is a method of generating an optical system topology (OST). An OST function, or retrieve OST function, is used to extract information from the TR database. This method can be described as a method of collecting information from and/or about a plurality of network elements. Rather than grouping network elements together based on physical site location as they appear physically, NEs are grouped together and displayed based on logical OSID membership. Providing an optical system topology as a graphical display exposes to the outside world the internal data model for shelves that are inter-related, including not just equipment that is co-located, but rather equipment from a collective of shelves in the same managed group. This discovered OST is advantageously represented by one or more data structures and communicated to other modules, such as the zoomable user interface, to enable those functions.

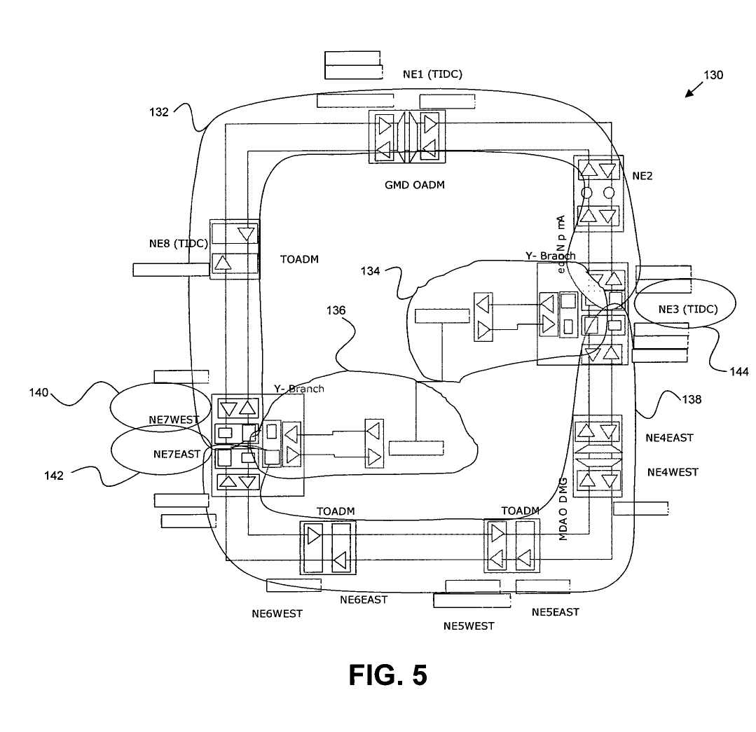

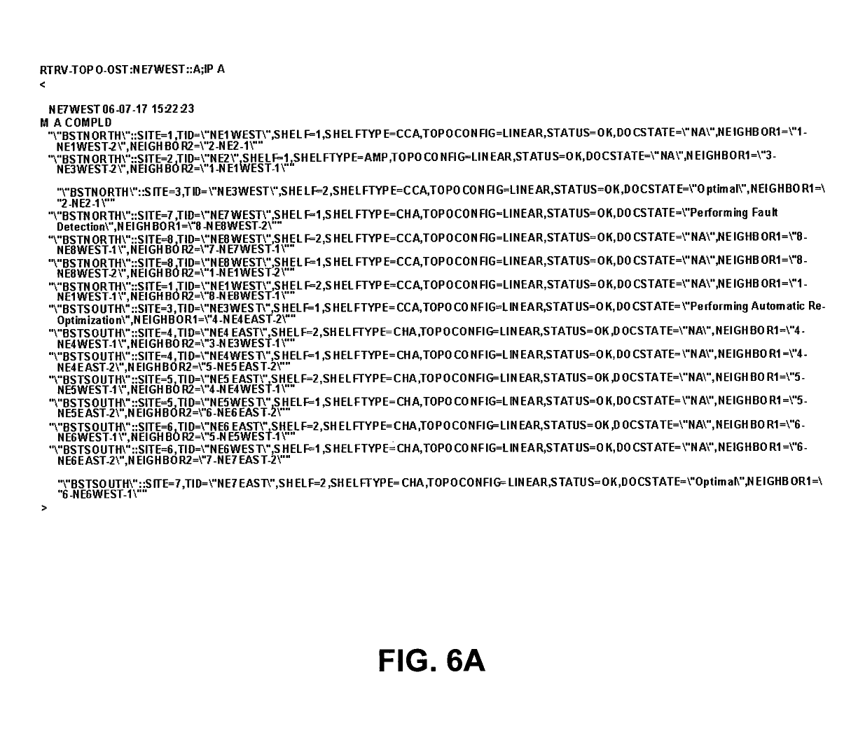

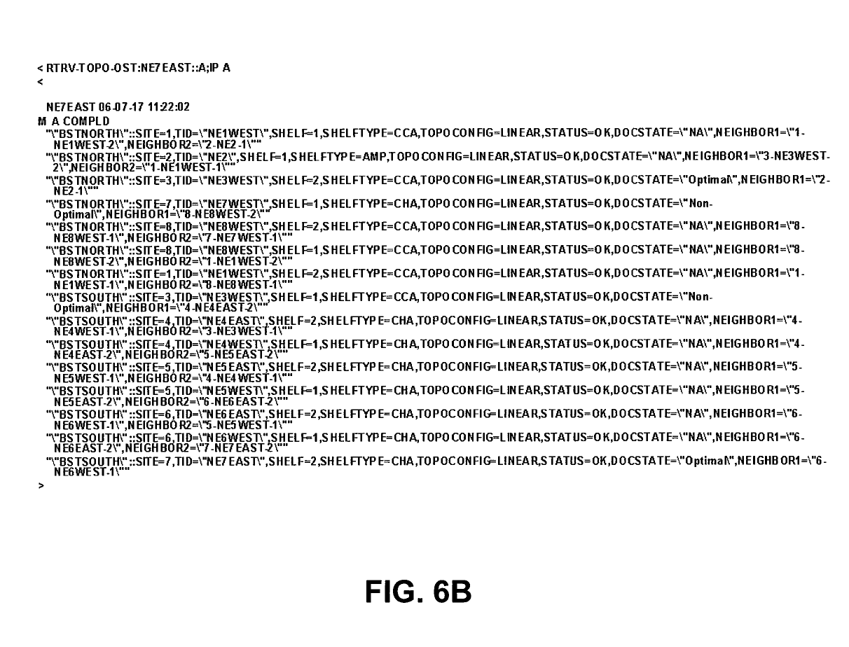

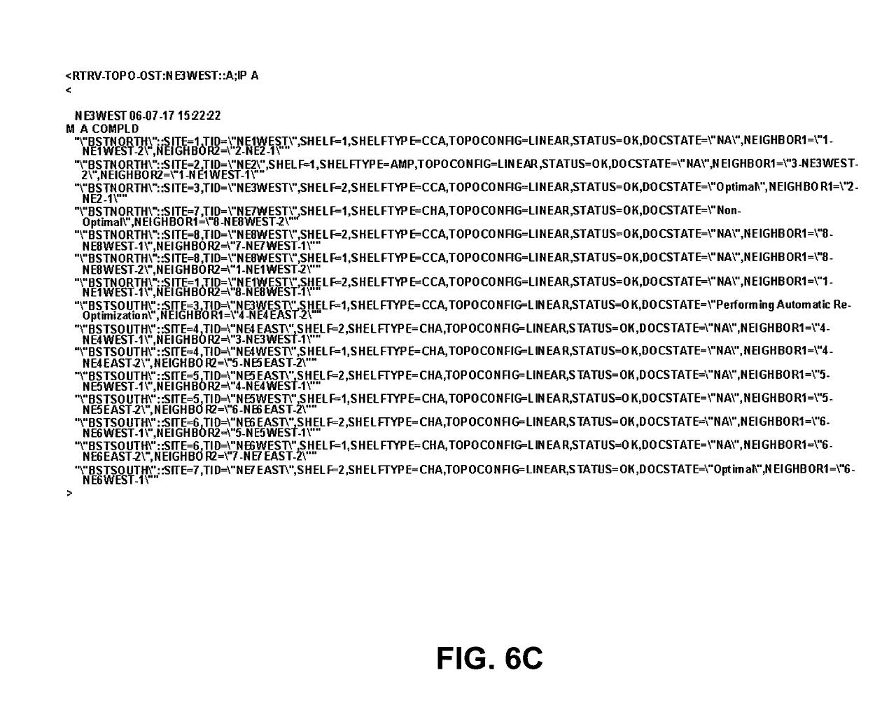

FIG. 5 illustrates an 8-span closed ring network topology 130 with four domains 132, 134, 136 and 138. The portion of network element 7 (NE7) in domain 132 is represented by 140, whereas the portion of NE7 in domain 138 is represented by 142. The portion of NE3 in domain 138 is represented by 144. When the OST application pulls information from the TR records, the OST data is extracted in text form, in a format that can be read by a GUI in order to display the OST. FIGS. 6A, 6B and 6C are exemplary OST data retrieve application outputs for elements 140, 142 and 144, respectively.

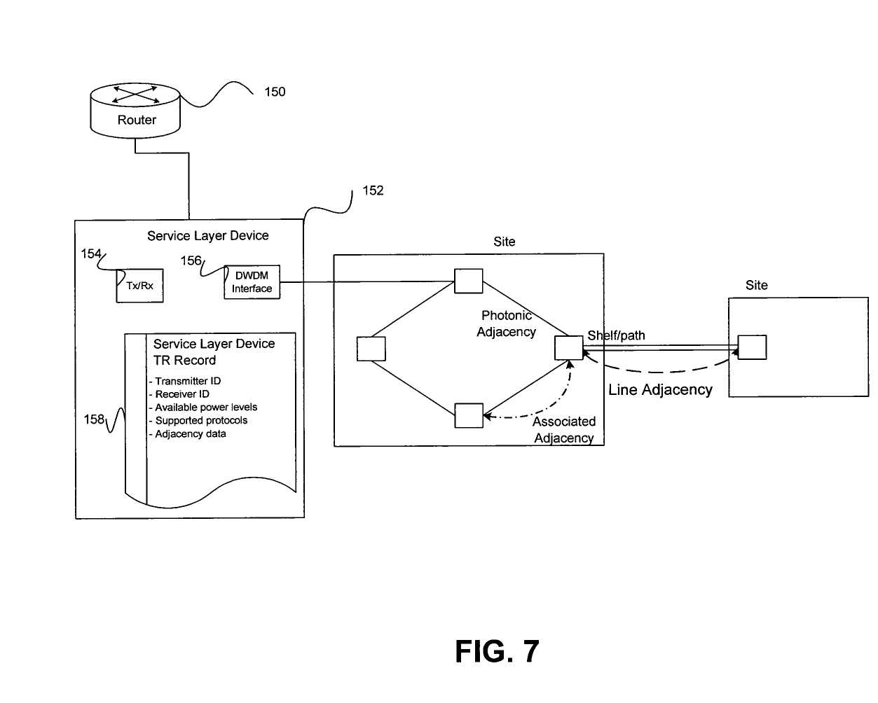

FIG. 7 illustrates a network topology showing photonic adjacency and service layer relationships. Photonic adjacency represents physically, based on the fiber plant, how to get from point A to point Z. Photonic adjacency between two network elements at the same site is shown in FIG. 7. This data is useful because there may be a case in which shelves can see each other and are inter-connected from a COMMS perspective but there may not be actual fiber between the two shelves. As such, even though a user can see them and know that they are associated, it may not be possible to send traffic directly between the two shelves. Representing photonic adjacencies helps to draw a better picture and also support cross domain provisioning, cross multi-branch-site provisioning, and multi-direction-branch-site provisioning. This also permits representing the physical layer as accurately as possible. In an embodiment, service layer data can advantageously be included in the TR data record.

Presently, while it is common to discuss how photonic devices are connected together, there is very little discussion of how service layer devices are connected together. The service layer is the traffic generation layer. The photonic layer takes an optical interface from that service and carries it, the photonic layer interface being a wavelength designation and a power level. In the service layer, the data is electrical and provides the electrical to optical transition. As shown in FIG. 7, a router 150 or some other device is connected to a service layer device 152. The service layer device 152 includes an actual transmitter and receiver, represented together as 154, that has a client interface carrying traffic, such as Ethernet, gigabit Ethernet or 10 gigabit Ethernet. A DWDM interface 156 in the service layer device interfaces with the optical shelf.

The TR protocol can be installed on the service layer devices to allow the common photonic layer (CPL) and the service layer to integrate together. Service layer devices are commonly know to talk to each other, such as by the SONET standard. All of this creates a stronger relationship between a service layer device and photonic layer or photonic equipment. Based on this integration, the service layer device and photonic layer device can be integrated into one network element, or one consolidated network element, running the same software. This integration is preferably achieved by way of a TR record 158 including service layer information. In a TR record 158 for a service layer device, the network element data can include: service layer device transmitter and receiver identification; and supported protocols. The relationship data can include: wavelength available, power levels available; and adjacency information, such as photonic adjacency information which indicates the fiber used to connect the service layer device to the photonic equipment.

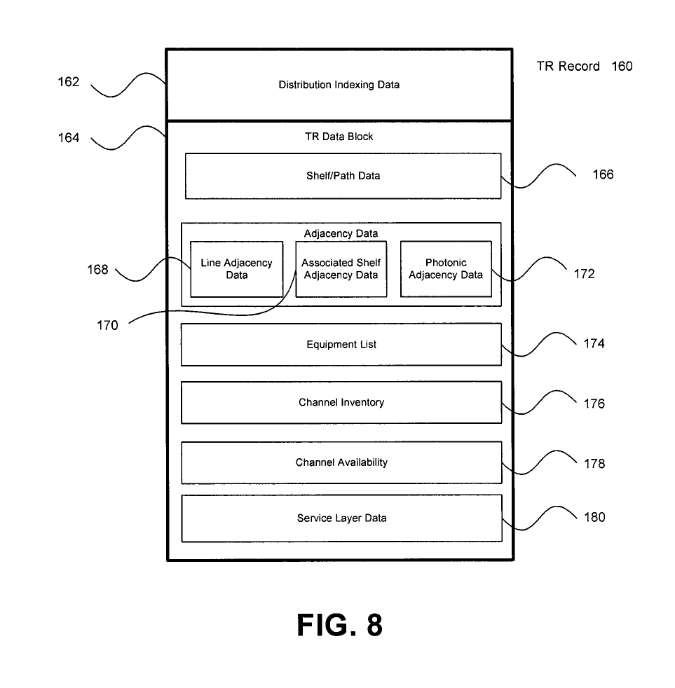

FIG. 8 illustrates a network topology data record 160 according to a further embodiment of the present invention. The distribution indexing data 162, TR data block 164, shelf/path data 166, line adjacency data 168 and associated shelf adjacency data 170 in FIG. 8 are similar to the distribution indexing data 102, TR data block 104, shelf/path data 106, line adjacency data 110 and associated shelf adjacency data 112 in FIG. 3. Photonic adjacency data 172 is illustrated in FIG. 8 and is stored in scenarios such as those in FIG. 7, to support applications where knowledge of photonic adjacency is advantageous, such as to represent service layer device adjacency.

Additional information is also stored in the TR record 160 can be used to enable applications such as end to end or A to Z provisioning and control plane integration. Equipment list data 174 can enable such applications and preferably includes channel mux and demux identification for every location. Channel inventory data 176 is also stored to indicate which channels are currently being added and dropped at this node. Channel availability data 178 indicates which of the existing channels are available to be used for data transmission, and can indicate which ones are owned by another application. Equipment and channel inventory data are powerful to enable A to Z provisioning and control plane integration since it is no longer necessary to log into each node to find out the capabilities of that node for adding and dropping traffic, since this data can now be obtain from the OST and TR data. Based on this TR data, it is possible to identify: which channels can be provisioned in the network; where a connection can start; where a connection can end; what paths a connection can take, etc. Service layer data 180 can include service layer device transmitter and receiver identification, supported protocols, wavelength available, and power levels available, as discussed in relation to FIG. 7.

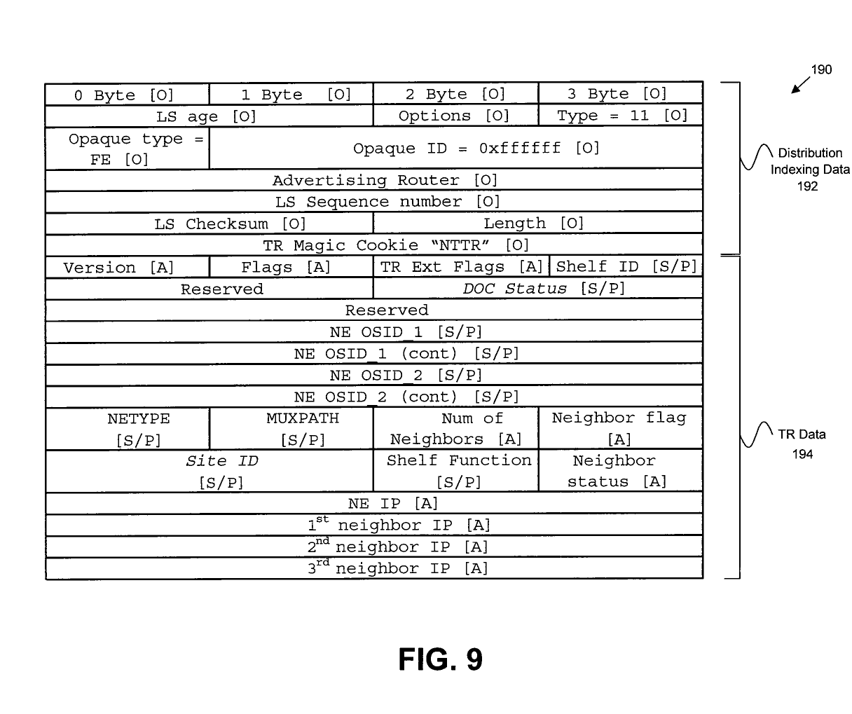

FIG. 9 illustrates an exemplary embodiment of a TR record 190. Distribution indexing data 192 is shown as OSPF header information. The TR data 194 is shown in a manner in which it can be arranged in the TR record, rather than as logical boxes. Shelf/path data is represented with the indication “[S/P]” and adjacency information as represented by “[A]”. In this particular embodiment, the shelf/path information includes: shelf ID; DOC status; NE OSID 1; NE OSID 2; NE Type; mux path; and shelf function. In this example adjacency information includes: version; flags; TR ext flags; number of neighbors; neighbor flag; neighbor status; NE IP, which signifies the NE IT address; first neighbor IP address; second neighbor IP address; and third neighbor IP address.

Methods and computer readable media according to embodiments of the present invention are both scalable to large networks. When domains are large, the optical paths may not be able to cross multiple domains. In some cases the domain may have regeneration within to support end to end traffic demands. For example, if the maximum reach for a particular network is 15 spans (typically 8 sections on average) then for this network an all optical demand could only transit 3 domains maximum. The methods and data records described herein support large numbers of interconnected linear and or ring topologies (domains). They also support networks of arbitrary size and arbitrary degree of optical branching. For example, a hypothetical network of network elements across North America could be discovered and queried.

In the preceding description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A computer readable medium storing a network topology data record, for network element management comprising:
distribution indexing data to facilitate distribution of the record;
network element data including technical characteristics of the selected network element; and
relationship data representing logical and physical relationships between the selected network element and other network elements, the relationship data including a network element grouping identifier representing a grouping to which the network element belongs.

2. The computer readable medium of claim 1 wherein the network element grouping identifier comprises a site identifier representing a physical grouping to which the network element belongs.

3. The computer readable medium of claim 1 wherein the network element grouping identifier comprises domain optical controller status data to indicate location.

4. The computer readable medium of claim 1 wherein the network element data comprises automatically discovered network element data.

5. The computer readable medium of claim 1 wherein the network element data comprises shelf/path data.

6. The computer readable medium of claim 1 wherein the relationship data comprises automatically discovered relationship data.

7. The computer readable medium of claim 1 wherein the relationship data comprises associated shelf adjacency data.

8. The computer readable medium of claim 1 wherein the relationship data comprises photonic adjacency data.

9. The computer readable medium of claim 1 wherein the relationship data comprises service layer adjacency data.

10. The computer readable medium of claim 1 wherein the network element data comprises service layer device transmitter and receiver data.

11. The computer readable medium of claim 1 wherein the network element data comprises channel inventory data.

12. The computer readable medium of claim 1 wherein the network element data comprises channel availability data.

13. The computer readable medium of claim 1 wherein the network element data comprises equipment list data.

14. A method of generating a network topology comprising:
automatically discovering network topology information based on element and relationship data stored at each network element, without user input; and
generating the network topology based on the automatically discovered network topology information.

15. The method of claim 14 wherein automatically discovering the network topology information comprises automatically discovering optical system topology information.

16. The method of claim 15 wherein generating the network topology comprises generating an optical system topology based on the automatically discovered optical system topology information.

17. The method of claim 14 further comprising storing the automatically discovered network topology information at a network level independent of a management layer.

18. The method of claim 14 further comprising identifying domain optical controller (DOC) sites based on the automatically discovered network topology information.

19. The method of claim 18 wherein identifying the DOC sites comprises identifying DOC sites within an OSID.

20. The method of claim 18 wherein identifying the DOC sites comprises identifying DOC sites in the entire network.

21. The method of claim 14 further comprising identifying all network elements associated with a DOC based on the automatically discovered network topology information.

22. The method of claim 14 further comprising tracing an optical channel path end to end based on the automatically discovered network topology information.

23. The method of claim 14 further comprising generating a list of shelves for a selected site.

24. The method of claim 14 wherein the step of generating the network topology comprises generating an ordered list of sections per network path by tracing network element interconnectiveness within an OSID.

25. The method of claim 14 further comprising validating a connection by comparing the automatically discovered network topology information with expected provisioning information.
